(19) United States
(12) Patent Application Publication
(10) Pub. No.: US 2023/0357550 A1
(43) Pub. Date: Nov. 9, 2023

(54) POLYOLEFIN COMPOSITIONS AND PRODUCTS

(71) Applicant: EQUISTAR CHEMICALS, LP, HOUSTON, TX (US)

(72) Inventors: BRYAN S. SCHLEY, CINCINNATI, OH (US); FABIO CECCARANI, YOUNGSTOWN, OH (US); RYAN KRAMB, MONROE, OH (US)

(73) Assignee: EQUISTAR CHEMICALS, LP, HOUSTON, TX (US)

(21) Appl. No.: 18/142,398

(22) Filed: May 2, 2023

Related U.S. Application Data
(60) Provisional application No. 63/337,752, filed on May 3, 2022.

(51) Int. Cl. C08F 110/08; C08J 5/18; C08F 2/00; C08L 23/14; C08F 2/34

(52) U.S. Cl. CPC C08L 23/142; C08F 2/001; C08F 2/34; C08F 110/08; C08J 5/18; C08L 2205/025; C08L 2205/03; C08L 2314/02; C08L 2314/06

(57) ABSTRACT

A composition comprising a blend of a propylene-based copolymer composition and a polybutene elastomer and having a balance of softness and strength in combination with enhanced optical properties is provided. A film comprising a propylene-based copolymer composition and a polybutene elastomer is also provided. The film can have the propylene-based copolymer composition and the polybutene elastomer as separate layers in a multilayer structure or a single layer can be formed from a blend of the propylene-based copolymer composition and the polybutene elastomer. Methods for making the compositions and films are also provided.

### CROSS REFERENCE TO RELATED APPLICATIONS

This application claims the benefit of priority to U.S. Provisional Application No. 63/337,752 filed on May 3, 2022, which is incorporated herein by reference in its entirety.

### FIELD OF THE DISCLOSURE

This invention relates to blends of propylene-based copolymer compositions and polybutene elastomers. Films produced from such blends or containing layers of propylene-based copolymer compositions and polybutene elastomers exhibit a useful combination of softness, strength, processability, and optical properties.

### BACKGROUND OF THE DISCLOSURE

Thermoplastic olefin (“TPO”) compositions typically comprise a blend of an olefinic homopolymer, such as polypropylene, with a rubbery copolymer of two different alpha olefins, such as an ethylene-octene copolymer. The rubbery copolymer improves the impact strength or toughness of the TPO composition, and it also lowers the tensile modulus or stiffness of the TPO composition. In contrast to such mechanical blends, the Catalloy™ process practiced by LyondellBasell, produces TPO resins as alloys of rubber and polypropylene produced sequentially in the polymerization reactors. These alloys provide a much better dispersion of the rubber in the TPO resin, which has a direct effect on the processing consistency and end-use properties.

Although TPO resins have long been used as skin layers for automotive interiors, some newer interior designs require an interior skin material that maintains a conventional appearance but also has translucent properties allowing light to be projected through the skin. This technology can create a day and night unique interior atmosphere, such as, but not limited to, allowing new locations and sizes of electronic indicators. Operation of this technology could be enhanced through use of interior skin material with a greater degree of transparency.

In addition to skin layers for automotive interiors, soft and transparent TPO resins would also be a benefit in a number of other applications including but not limited to newly developed photovoltaic (PV) systems. The soft and transparent TPO resins can be used as an encapsulant material for the PV cells and as a transparent front sheet to protect the encapsulation film. In such PV systems, the solar cell could be encased inside a soft transparent sheet that allows light to pass through to the PV electronic components while allowing the sheet as a whole to be flexible.

These new automotive interior designs and PV system applications have created a need for TPO compositions having a balance of mechanical properties comparable to existing TPO resins in combination with greater transparency. A valuable approach would avoid expensive additives and performance tradeoffs. Ideally, improved TPO compositions could be made using economical starting materials, commonly-used equipment, and familiar techniques.

### SUMMARY OF THE DISCLOSURE

In general, the present disclosure relates to compositions and films and/or sheets that contain a propylene-based copolymer composition and a polybutene elastomer and methods for making such compositions, and films and/or sheets produced therefrom. In some film embodiments, the propylene-based copolymer composition and a polybutene elastomer are blended to produce a single-layer film. In other film embodiments, a core layer of polybutene elastomer is disposed between two outer layers of a propylene-based copolymer composition. In yet other embodiments, the compositions and films disclosed herein have a haze value less than or equal to 30% and a tensile modulus (Young’s modulus) in the range of from 10 MPa to 350 MPa. The combination of the propylene-based copolymer composition and the polybutene elastomer has comparable softness and strength as some existing TPO resins in combination with improved optical properties.

The propylene-based copolymer composition is a blend of at least two random copolymers of propylene and one or more α-olefins, such that the units derived from the different monomers and/or comonomers occur randomly along the polymer chain; wherein the α-olefins are selected from ethylene and C₄-C₈ monomers, from ethylene and C₄-C₆ monomers, or from ethylene and butene. This is in direct contrast to block copolymers or terpolymers in which a plurality of common monomeric units are grouped together to form sections of homopolymer along the polymer backbone.

In some embodiments, the monomeric units of the random propylene-based copolymer composition are derived from ethylene, propylene, and butene. In some embodiments, the propylene-based copolymer composition has a melt flow rate (230° C./2.16 kg) in the range of from 0.9 g/10 min. to 7.5 g/10 min., a density in the range of from 0.88 g/cm³ to 0.92 g/cm³, a tensile modulus in the range of from 100 MPa to 700 MPa, or any combination thereof. In some embodiments, the polymerization process comprises use of a spherical Ziegler-Natta catalyst, two or more (in some instances at least three) gas phase reactors in series operation, or a combination thereof. In different embodiments, the propylene-based copolymer composition can be characterized by any combination or all of the aforementioned characteristics and attributes.

In some embodiments, the polybutene elastomer is a copolymer obtained by the polymerization of butene-1 and ethylene. In some embodiments, the polybutene elastomer has a melt flow rate (190° C./2.16 kg) in the range of from 0.5 g/10 min. to 4 g/10 min., a density in the range of from 0.870 g/cm³ to 0.915 g/cm³, a tensile modulus in the range of from 1 MPa to 50 MPa, a tensile elongation at break of greater than or equal to 300%, 400%, 500% or 600%, or any combination thereof. In some embodiments, the polybutene elastomer is polymerized in a process comprising a metallocene catalyst, a Ziegler-Natta catalyst, or a combination thereof. In different embodiments, the polybutene elastomer can be characterized by any combination or all of the aforementioned characteristics and attributes.

The foregoing has outlined rather broadly the features and technical advantages of the present disclosure in order that the detailed description of the disclosure that follows may be better understood. Additional features and advantages of the disclosure will be described hereinafter, which form the subject matter of the claims of the disclosure. It should be appreciated by those skilled in the art that the conception and specific embodiments disclosed may be readily utilized as a basis for modifying or designing other film structures and/or processes for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its structure and method of manufacture, together with further objects and advantages will be better understood from the following description.

### DETAILED DESCRIPTION OF THE INVENTION

Illustrative embodiments of the subject matter claimed below will now be disclosed. In the interest of clarity, some features of some actual implementations may not be described in this specification. It will be appreciated that in the development of any such actual embodiments, numerous implementation-specific decisions must be made to achieve the developer’s specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than the broadest meaning understood by skilled artisans, such a special or clarifying definition will be expressly set forth in the specification in a definitional manner that provides the special or clarifying definition for the term or phrase.

For example, the following discussion contains a non-exhaustive list of definitions of several specific terms used in this disclosure (other terms may be defined or clarified in a definitional manner elsewhere herein). These definitions are intended to clarify the meanings of the terms used herein. It is believed that the terms are used in a manner consistent with their ordinary meaning, but the definitions are nonetheless specified here for clarity.

### Definitions

“About” means the stated value plus or minus the margin of error of measurement or plus or minus 10% if no method of measurement is indicated.

“Compounding conditions,” as used herein, means melt conditions induced by temperature, pressure, and shear force conditions implemented in an extruder to provide intimate mixing of two or more polymers and optionally additives to produce a substantially homogeneous polymer product. However, such temperature, pressure, and shear force conditions are limited to prevent chain scission and/or crosslinking of the blend components in the extruder, or alternatively, to limit chain scission and/or crosslinking of the blend components in the extruder to produce an intimate blend of the mixed components that each retain their original character.

“Film,” as used herein, is intended to include films (thickness ≤ 10 mil (0.25 mm)) or sheets (thickness ≥ 10 mil (0.25 mm)) as defined in “ASTM D883 - Standard Terminology relating to plastics.” In some embodiments, to the term “film” as used herein is intended to include polymer films or sheets having a thickness range of from greater than 0 to 100 mil (2.5 mm).

“Processability,” as used herein, means an assessment of whether a polymer can be successfully formed into a cast film of commercial quality at commercially acceptable rates using the equipment and conditions described in the examples later in this specification. A polymer composition had good processability if it could be processed into a film capable of being subjected to the film property tests herein and if it was believed that such polymer could be run continuously through the cast film apparatus at the stated conditions in a substantially steady state manner. A polymer composition did not have good processability if it could not be processed into a film capable of being subjected to the film property tests herein or if it was believed that such polymer could not be run continuously through the cast film apparatus at the stated conditions in a substantially steady state manner.

### Blend Composition

Some new automotive interior designs, as well as recently developed PV systems, require a greater degree of transparency than offered by many TPO resins currently used as skins on dashboards and other interior surfaces. Combinations of dissimilar polymers disclosed herein provides a useful balance of softness, strength, processability, and optical properties that can meet the requirements of some of these new automotive interior designs and PV systems.

It has been discovered that blends of one or more propylene-based copolymer compositions with one or more polybutene elastomers provides for various combinations of softness strength and transparency. In some embodiments, the amount of the one or more propylene-based copolymer compositions present in the blend composition is in the range of from 20 wt.% to 80 wt.%, from 21 wt.% to 70 wt.%, from 22 wt.% to 60 wt.%, from 23 wt.% to 50 wt.%, from 24 wt.% to 40 wt.%, or from 25 wt.% to 35 wt.%, wherein all weight percentages are based on the total weight of the one or more propylene-based copolymer compositions and the one or more polybutene elastomers. Correspondingly, the amount of the one or more polybutene elastomers present in the blend composition is in the range of from 20 wt.% to 80 wt.%, from 30 wt.% to 79 wt.%, from 40 wt.% to 78 wt.%, from 50 wt.% to 77 wt.%, from 60 wt.% to 76 wt.%, or from 65 wt.% to 75 wt.%, wherein all weight percentages are based on the total weight of the one or more propylene-based copolymer compositions and the one or more polybutene elastomers.

In some embodiments, the blend composition comprising the one or more propylene-based copolymer compositions and the one or more polybutene elastomers has a haze value of less than or equal to 23%, less than or equal to 20%, less than or equal to 17%, less than or equal to 14%, or less than or equal to 10%.

In some embodiments, the blend composition comprising the one or more propylene-based copolymer compositions and the one or more polybutene elastomers has a tensile modulus in the range of from 10 MPa to 350 MPa, from 15 MPa to 300 MPa, from 20 MPa to 250 MPa, from 25 MPa to 200 MPa, or from 30 MPa to 175 MPa.

In some embodiments, the one or more propylene-based copolymer compositions and the one or more polybutene elastomers are blended by adding the blend components to an extruder in flake and/or pellet form, and subjecting the physical mixture to compounding conditions sufficient to intimately mix the blend components to form a blend melt composition without substantial alteration of the original blend components. The blend melt composition can be extruded to form a cast film.

### Propylene-Based Copolymer Compositions

The propylene-based copolymer composition comprises random copolymers of propylene and one or more α-olefins, such that the units derived from the different monomers and/or comonomers occur randomly along the polymer chain. Exemplary propylene-based copolymer compositions and methods for producing such compositions are disclosed in U.S. Pat. No. 6,395,831, which is fully incorporated herein by reference for all jurisdictions in which such incorporation is permitted. This is in contrast to block copolymers or terpolymers in which a plurality of common monomeric units are grouped together to form sections of homopolymer along the polymer backbone.

In some embodiments, the monomeric units of the propylene-based copolymer composition are derived from ethylene, propylene, and a C₄-C₈ monomer; from ethylene, propylene, and a C₄-C₆ monomer; or, from ethylene, propylene, and butene.

In some embodiments, the propylene-based copolymer composition comprises a propylene-based polyolefin having a melt flow rate between 2 to 15 g/10 min., wherein the MFR values are measured according to ASTM D 1238 (230° C./2.16 kg). The propylene-based polyolefin can have a semicrystalline propylene copolymer composition having: (A) 20-80 wt.% of one or more propylene-based components selected from the group consisting of propylene/ethylene copolymers containing 1-7 wt.% of ethylene; copolymers of propylene with one or more C₄-C₈ α-olefins, containing 2-10 wt.% of the C₄-C₈ α-olefins; or terpolymers of propylene with ethylene and one or more C₄-C₈ α-olefins, containing 0.5-4.5 wt.% of ethylene and 2-6 wt.% of C₄-C₈ α-olefins, provided that the total content of ethylene and C₄-C₈ α-olefins be equal to or lower than 6.5 wt.%; and (B) 20-80 wt.% of one or more propylene-based components selected from the group consisting of copolymers of propylene with one or more C₄-C₈ α-olefins, containing from more than 10 wt.% to 30 wt.% of C₄-C₈ α-olefins, or terpolymers of propylene with ethylene and one or more C₄-C₈ α-olefins, containing 1-7 wt.% of ethylene and 6-15 wt.% of C₄-C₈ α-olefins. Alternatively, the propylene-based polyolefin can have a semicrystalline propylene copolymer composition having: (A) about 35 wt.% of one or more propylene-based components selected from the group consisting of propylene/ethylene copolymers containing about 3.7 wt.% of ethylene; copolymers of propylene with one or more C₄-C₈ α-olefins, containing 2-10 wt.% of the C₄-C₈ α-olefins; or terpolymers of propylene with ethylene and one or more C₄-C₈ α-olefins, containing 0.5-4.5 wt.% of ethylene and 2-6 wt.% of C₄-C₈ α-olefins, provided that the total content of ethylene and C₄-C₈ α-olefins in be equal to or lower than 6.5 wt.%; and (B) about 65 wt.% of one or more propylene-based components selected from the group consisting of copolymers of propylene with one or more C₄-C₈ α-olefins, containing from more than 10 wt.% to 30 wt.% of C₄-C₈ α-olefins, or terpolymers of propylene with ethylene and one or more C₄-C₈ α-olefins, containing about 3.3 wt.% of ethylene and about 10 wt.% of a C₄ α-olefins. Alternatively, the propylene-based polyolefin can have a semicrystalline propylene copolymer composition having: (A) about 35 wt.% of a propylene-based component that is a propylene/ethylene copolymer containing about 3.7 wt.% of ethylene; and (B) about 65 wt.% of a propylene-based component that is a terpolymer of propylene with ethylene and a C4 α-olefins, containing about 3.3 wt.% of ethylene and about 10 wt.% of a C4 α-olefins. In some embodiments, the propylene-based copolymer composition has a density in the range of from 0.88 g/cm³ to 0.92 g/cm³, from 0.88 g/cm³ to 0.92 g/cm³, from 0.89 g/cm³ to 0.91 g/cm³, from 0.895 g/cm³ to 0.905 g/cm³, or from 0.898 g/cm³ to 0.902 g/cm³.

In some embodiments, the propylene-based copolymer composition has a tensile modulus in the range of from 100 MPa to 1,000 MPa, from 150 MPa to 950 MPa, from 250 MPa to 900 MPa, from 350 MPa to 850 MPa, or from 450 MPa to 800 MPa.

In some embodiments, the propylene-based copolymer composition is produced in a polymerization process, such as, but not limited to the Catalloy™ process (practiced by LyondellBasell). In some embodiments, the polymerization process comprises use of a spherical Ziegler-Natta catalyst, two or more (in some instances at least three) gas phase reactors in series operation, or a combination thereof.

In some embodiments, the propylene-based copolymer composition, or a film formed from the propylene-based copolymer composition, has a gloss greater than or equal to 50 GU, greater than or equal to 60 GU, greater than or equal to 70 GU, greater than or equal to 80 GU, or greater than or equal to 90 GU.

In some embodiments, the propylene-based copolymer composition, or a film formed from the propylene-based copolymer composition and having a thickness of less than or equal to 20 mil (0.51 mm), has a haze less than or equal to 45%, less than or equal to 35%, less than or equal to 25%, or less than or equal to 15%.

In some embodiments, the propylene-based copolymer composition, or a film formed from the propylene-based copolymer composition, has a tensile stress at break in the range of from 15 MPa to 75 MPa, from 20 MPa to 55 MPa, from 25 MPa to 45 MPa, or from 30 MPa to 35 MPa.

In some embodiments, the propylene-based copolymer composition, or a film formed from the propylene-based copolymer composition, has an elongation at break in the range of from 50% to 500%, from 100% to 400%, from 150% to 300%, or from 200% to 250%.

In different embodiments, the propylene-based copolymer composition can be characterized by any combination or all of the aforementioned attributes.

### Polybutene Elastomer

In some embodiments, the polybutene elastomer obtained by the polymerization of butene-1 and ethylene. Such polybutene elastomers and methods for producing such compositions are disclosed in PCT Pub. No. WO 2009/000637, which is fully incorporated herein by reference for all jurisdictions in which such incorporation is permitted.

In some embodiments, the polybutene elastomer has a melt flow rate (190° C./2.16 kg) in the range of from 0.5 g/10 min. to 4 g/10 min., a density in the range of from 0.870 g/cm³ to 0.915 g/cm³, a tensile modulus in the range of from 1 MPa to 100 MPa, from 2 MPa to 90 MPa, from 3 MPa to 80 MPa, from 4 MPa to 70 MPa, from 5 MPa to 60 MPa, or from 10 MPa to 50 MPa, a tensile elongation at break of greater than or equal to 300%, 400%, 500% or 600%,, or any combination thereof.

In some embodiments, the polybutene elastomer has an ethylene-derived unit content in the range of from 15.10% by mol to 18.00% by mol, from 15.50% by mol to 17% by mol, or from 15.50% by mol to 16.50% by mol, and having the following properties:
a) a molecular weight distribution M_{w}/Mₙ less than 3;
b) hardness shore A (measured according to ISO 868) less than 65, or less than 60;
c) tension set less than 30% or less than 20% at 100% of deformation (ISO 2285);
d) no melting point detectable by a DSC, measured according to the methods described below; and
e) melting enthalpy, measured after 10 days of aging at room temperature and measured according to the methods described below, in the range of from 4 J/g to 15 J/g, or from 5 J/g to 10 J/g.

In some embodiments, the polybutene elastomer has a good balance between hardness and elastic behavior better described in term of tension set, other than it shows good values of clarity.

In some embodiments, the polybutene elastomer does not show a melting point after it has been melted according to the common DSC procedure; however, it is crystallizable, i.e. about 10 days after it has been melted, the copolymer shows a melting point and a melting enthalpy.

In some embodiments, the polybutene elastomer has a tensile stress at break measured according to ISO 527 in the range of from 3 MPa to 20 MPa, or from 4 MPa and 13 MPa.

In some embodiments, the polybutene elastomer has an elongation at break measured according to ISO 527 in the range of from 550% to 800%, or from 600% to 750%.

In some embodiments, the polybutene elastomer has a high molecular weight, expressed in terms of an intrinsic viscosity (“IV”) greater than 1, greater than 1.5, or greater than 2. In some embodiments, the IV is less than or equal to 3.

In some embodiments, the polybutene elastomer, or a film formed from the polybutene elastomer, has a tensile modulus in the range of from 6 MPa to 30 MPa, from 8 MPa to 25 MPa, from 10 MPa to 20 MPa, or from 12 MPa to 15 MPa.

In some embodiments, the polybutene elastomer, or a film formed from the polybutene elastomer, has a gloss less than or equal to 25 GU, less than or equal to 20 GU, less than or equal to 15 GU, less than or equal to 12 GU, or less than or equal to 10 GU.

In some embodiments, the polybutene elastomer, or a film formed from the polybutene elastomer, has haze greater than or equal to 60%, greater than or equal to 65%, greater than or equal to 70%, greater than or equal to 75%, greater than or equal to 80%, or greater than or equal to 85%.

In some embodiments, the polybutene elastomer, or a film formed from the polybutene elastomer, has a tensile stress at break in the range of from 6 MPa to 30 MPa, from 7 MPa to 25 MPa, from 8 MPa to 20 MPa, from 25 MPa to 9 MPa, or from 10 MPa to 12 MPa.

In some embodiments, the polybutene elastomer, or a film formed from the polybutene elastomer, has an elongation at break greater than or equal to 300%, greater than or equal to 400%, greater than or equal to 500%, greater than or equal to 600%, greater than or equal to 700%, or greater than or equal to 800%.

In some embodiments, the polybutene elastomer, or a film formed from the polybutene elastomer, has puncture resistance in the range of from 4.0 N to 5.0 N, from 3.5 N to 5.5 N, from 3.0 N to 6.0 N, from 2.5 N to 6.5 N, or from 2.0 N to 7.0 N.

In some embodiments, the polybutene elastomer, or a film formed from the polybutene elastomer, has a Shore A hardness (after 15 seconds) in the range of from 50 to 70, from 52 to 68, from 53 to 67, from 54 to 66, or from 55 to 65.

In some embodiments, the polybutene elastomer, or a film formed from the polybutene elastomer, has a transverse tear resistance maximum extension in the range of from 80 mm to 130 mm, from 85 mm to 125 mm, from 90 mm to 120 mm, from 95 mm to 115 mm, or from 100 mm to 110 mm.

In different embodiments, the polybutene elastomer can be characterized by any combination or all of the aforementioned characteristics and attributes.

### Film

Films disclosed herein comprise one or more propylene-based copolymer compositions as described above and one or more polybutene elastomers as described above.

In some embodiments, a film comprising the blend composition comprising the one or more propylene-based copolymer compositions and the one or more polybutene elastomers has a tensile modulus in the range of from 10 MPa to 350 MPa, from 15 MPa to 300 MPa, from 20 MPa to 250 MPa, from 25 MPa to 200 MPa, or from 30 MPa to 175 MPa.

In some embodiments, a film comprising the blend composition comprising the one or more propylene-based copolymer compositions and the one or more polybutene elastomers has a gloss greater than or equal to 15 GU, greater than or equal to 25 GU, greater than or equal to 35 GU, greater than or equal to 45 GU, greater than or equal to 55 GU, or greater than or equal to 65 GU.

In some embodiments, a film comprising the blend composition comprising the one or more propylene-based copolymer compositions and the one or more polybutene elastomers has haze less than or equal to 65%, less than or equal to 55%, less than or equal to 45%, less than or equal to 35%, less than or equal to 25%, or less than or equal to 15%.

In some embodiments, a film comprising the blend composition comprising the one or more propylene-based copolymer compositions and the one or more polybutene elastomers has a transmittance of greater than or equal to 90%, greater than or equal to 92%, greater than or equal to 95%, when the film is at least 0.5 mm thick.

In some embodiments, a film comprising the blend composition comprising the one or more propylene-based copolymer compositions and the one or more polybutene elastomers has a tensile stress at break in the range of from 1 MPa to 100 MPa, from 2 MPa to 80 MPa, from 20 MPa to 60 MPa, from 25 MPa to 45 MPa, or from 15 MPa to 30 MPa.

In some embodiments, a film comprising the blend composition comprising the one or more propylene-based copolymer compositions and the one or more polybutene elastomers has an elongation at break greater than or equal to 300%, greater than or equal to 400%, greater than or equal to 500%, greater than or equal to 600%, greater than or equal to 700%, or greater than or equal to 800%.

In some embodiments, a film comprising the blend composition comprising the one or more propylene-based copolymer compositions and the one or more polybutene elastomers has a 1% secant modulus of from 30 MPa to 360 MPa, from 40 MPa to 250 MPa, from 50 MPa to 200 MPa, or from 60 MPa to 150 MPa.

In some embodiments, a film comprising the blend composition comprising the one or more propylene-based copolymer compositions and the one or more polybutene elastomers has puncture resistance greater than or equal to 75 N, greater than or equal to 80 N, greater than or equal to 85 N, greater than or equal to 90 N, or greater than or equal to 100 N.

In some embodiments, a film comprising the blend composition comprising the one or more propylene-based copolymer compositions and the one or more polybutene elastomers has a Shore A hardness (after 15 seconds) in the range of from 50 to 90, from 55 to 85, from 60 to 80, or from 65 to 75.

In some embodiments, a film comprising the blend composition comprising the one or more propylene-based copolymer compositions and the one or more polybutene elastomers has a machine direction tear resistance of greater than or equal to 25 N, greater than or equal to 35 N, greater than or equal to 45 N, greater than or equal to 55 N, greater than or equal to 65 N, or greater than or equal to 75 N.

In some embodiments, a film comprising the blend composition comprising the one or more propylene-based copolymer compositions and the one or more polybutene elastomers has a normalized machine direction tear resistance of greater than or equal to 50 N/mm, greater than or equal to 70 N/mm, greater than or equal to 90 N/mm, greater than or equal to 110 N/mm, greater than or equal to 130 N/mm, or greater than or equal to 150 N/mm.

In some embodiments, a film comprising the blend composition comprising the one or more propylene-based copolymer compositions and the one or more polybutene elastomers has a machine direction tear resistance maximum extension of greater than or equal to 50 mm, greater than or equal to 60 mm, greater than or equal to 70 mm, greater than or equal to 80 mm, greater than or equal to 90 mm, or greater than or equal to 100 mm.

In some embodiments, a film comprising the blend composition comprising the one or more propylene-based copolymer compositions and the one or more polybutene elastomers has a transverse direction tear resistance of greater than or equal to 25 N, greater than or equal to 35 N, greater than or equal to 45 N, greater than or equal to 55 N, greater than or equal to 65 N, or greater than or equal to 75 N.

In some embodiments, a film comprising the blend composition comprising the one or more propylene-based copolymer compositions and the one or more polybutene elastomers has a normalized transverse direction tear resistance of greater than or equal to 50 N/mm, greater than or equal to 70 N/mm, greater than or equal to 90 N/mm, greater than or equal to 110 N/mm, greater than or equal to 130 N/mm, or greater than or equal to 150 N/mm.

In some embodiments, a film comprising the blend composition comprising the one or more propylene-based copolymer compositions and the one or more polybutene elastomers has a transverse tear resistance maximum extension of greater than or equal to 50 mm, greater than or equal to 60 mm, greater than or equal to 70 mm, greater than or equal to 80 mm, greater than or equal to 90 mm, or greater than or equal to 100 mm.

In different embodiments, a film comprising the blend compositions or films comprising blend compositions, as disclosed herein, can be characterized by any combination or all of the aforementioned attributes.

In some embodiments, the film comprising the one or more propylene-based copolymer compositions and the one or more polybutene elastomers has a thickness in the range of from 5 mil (127 µm) to 25 mil (635 µm) or from 10 mil (254 µm) to 20 mil (508 µm).

In some embodiments, the film comprising the one or more propylene-based copolymer compositions and the one or more polybutene elastomers comprises two outer layers comprising the propylene-based copolymer composition and a core layer comprising the polybutene elastomer, wherein the core layer is disposed between the two outer layers. In some embodiments, the thickness of the core layer is in the range of from 50% to 85%, from 55% to 83%, from 60% to 81%, from 65% to 79%, or from 70% to 77%, wherein the percentage is based on the combined thickness of the core layer and two outer layers in the film. Additionally, in some further embodiments, the film has a thickness in the range of from 5 mil (127 µm) to 25 mil (635 µm) or from 10 mil (254 µm) to 20 mil (508 µm), while having a core layer thickness in the range of from 50% to 85%, from 55% to 83%, from 60% to 81%, from 65% to 79%, or from 70% to 77% of the film thickness.

In some embodiments, in a cast film coextrusion process, at least three polymer layers are coextruded to produce a layer configuration A/B/A, where A comprises a propylene-based copolymer composition and B comprises a polybutene elastomer as a core layer. In such multilayer coextrusion cast film process, polymers for each layer are heated in separate extruders. When melted polymers reach the end of the barrel of each extruder, the polymers are coextruded through a multilayer flat die system to adopt its final shape. After exiting the die, the multilayer melt enters a cooling unit where its temperature is lowered with a water-cooled chill roll to solidify the film.

In some embodiments, the one or both outer layers comprising one or more propylene-based copolymer compositions further comprises one or more polybutylene elastomers. In some embodiments, the core layer comprising one or more polybutylene elastomers further comprises one or more propylene-based copolymer compositions. In some embodiments, the core layer and one or both outer layers comprise one or more propylene-based copolymer compositions and one or more polybutylene elastomers.

In some embodiments, the film comprising the one or more propylene-based copolymer compositions and the one or more polybutene elastomers, the propylene-based copolymer composition and the polybutene elastomer are blended under melt conditions to form a blend composition, and the film is formed from the blend composition.

In some embodiments, a cast film extrusion process, the blend of one or more propylene-based copolymer compositions and the one or more polybutene elastomers is melted in one or more extruders and extruded or coextruded to form a single-layer film comprising the blend of one or more propylene-based copolymer compositions and the one or more polybutene elastomers.

In some embodiments, three extruders feed a five-layer cast film apparatus to produce a three-layer film of configuration A-3/B-2/B-1/B-2/A-3 (i.e., extruder 1 to core layer, extruder 2 to sublayers adjacent to core layer, and extruder 3 to outer layers, as controlled by die splits), wherein A is one or more propylene-based copolymer compositions and B is one or more polybutene elastomers, and the interface between the B layers is not retained when the layers of the polybutene melt are coextruded together.

In some embodiments, three extruders feed a five-layer cast film apparatus to produce a single-layer film of configuration AB-3/AB-2/AB-1/AB-2/AB-3 (i.e., extruder 1 to core layer, extruder 2 to sublayers adjacent to core layer, and extruder 3 to outer layers, as controlled by die splits), wherein AB is a blend of one or more propylene-based copolymer compositions and one or more polybutene elastomers, and the interface between the AB layers is not retained when the layers of the AB blend melt are coextruded together.

The general process for forming a single-layer or three-layer structure using a cast film apparatus suited to make five or more layers can be controlled by feeding common polymers to one or more adjacent layers. The single or multilayer structures can be in the form of films or sheets, which may be further thermoformed or oriented, and can be produced using conventional methods and extrusion equipment known to those skilled in the art, where layers of polymer melts are combined by introducing multiple polymer melt streams into a combining block/manifold or die which then directs the melt streams to flow together (while still in the block/manifold or die), then exiting the die together as a single flow stream. Alternately, multiple polymer melt streams can be introduced into a die and then combined just after exiting the die.

### Certain Embodiments

In some embodiments, the film consists essentially of a blend of:
(A) one or more propylene-based copolymer compositions present in the blend composition in the range of from about 20 wt.% to 80 wt.%, from 21 wt.% to 70 wt.%, from 22 wt.% to 60 wt.%, from 23 wt.% to 50 wt.%, from 24 wt.% to 40 wt.%, from 55 wt.% to 80 wt.%, or from 25 wt.% to 35 wt.%, wherein all weight percentages are based on the total weight of the one or more propylene-based copolymer compositions and the one or more polybutene elastomers, and each propylene-based copolymer composition is characterized by one or more of:
   (1) is a blend of random copolymers of propylene and one or more α-olefins, such that the units derived from the different monomers and/or comonomers occur randomly along the polymer chain; wherein the α-olefins are selected from ethylene and C₄-C₈ monomers, from ethylene and a C₄-C₆ monomers, or from ethylene and butene; and/or
   (2) is a semicrystalline propylene copolymer composition having: (A) 20-80 wt.% of one or more propylene-based components selected from the group consisting of propylene/ethylene copolymers containing 1-7 wt.% of ethylene; copolymers of propylene with one or more C₄-C₈ α-olefins, containing 2-10 wt.% of the C₄-C₈ α-olefins; or terpolymers of propylene with ethylene and one or more C₄-C₈ α-olefins, containing 0.5-4.5 wt.% of ethylene and 2-6 wt.% of C₄-C₈ α-olefins, provided that the total content of ethylene and C₄-C₈ α-olefins in be equal to or lower than 6.5 wt.%; and (B) 20-80 wt.% of one or more propylene-based components selected from the group consisting of copolymers of propylene with one or more C₄-C₈ α-olefins, containing from more than 10 wt.% to 30 wt.% of C₄-C₈ α-olefins, or terpolymers of propylene with ethylene and one or more C₄-C₈ α-olefins, containing 1-7 wt.% of ethylene and 6-15 wt.% of C₄-C₈ α-olefins; and/or
   (3) has a melt flow rate between 2 to 15 g/10 min.; and/or
   (4) has a density in the range of from 0.88 g/cm³ to 0.92 g/cm³, from 0.88 g/cm3 to 0.92 g/cm³, from 0.89 g/cm³ to 0.91 g/cm³, from 0.895 g/cm³ to 0.905 g/cm³, or from 0.898 g/cm³ to 0.902 g/cm³; and/or
   (5) has a tensile modulus in the range of from 100 MPa to 1,000 MPa, from 150 MPa to 950 MPa, from 250 MPa to 900 MPa, from 350 MPa to 850 MPa, or from 450 MPa to 800 MPa; and/or
   (6) has a gloss greater than or equal to 50 GU, greater than or equal to 60 GU, greater than or equal to 70 GU, greater than or equal to 80 GU, or greater than or equal to 90 GU; and/or
   (7) has haze less than or equal to 45%, less than or equal to 35%, less than or equal to 25%, or less than or equal to 15%; and/or
   (8) has a tensile stress at break in the range of from 15 MPa to 75 MPa, from 20 MPa to 55 MPa, from 25 MPa to 45 MPa, or from 30 MPa to 35 MPa;
   (9) has an elongation at break in the range of from 50% to 500%, from 100% to 400%, from 150% to 300%, or from 200% to 250%; and/or
   (10) has a 1% secant modulus of from 5 MPa to 30 MPa, from 6 MPa to 25 MPa, from 8 MPa to 20 MPa, or from 10 MPa to 15 MPa; and/or
   (11) in some embodiments, the propylene-based copolymer composition or a film formed from the propylene-based copolymer composition has a 2% secant modulus of from 200 MPa to 650 MPa, from 250 MPa to 600 MPa, from 300 MPa to 550 MPa, or from 350 MPa to 500 MPa; and
(B) one or more polybutene elastomers present in the blend composition in the range of from about 20 wt.% to 80 wt.%, from 30 wt.% to 79 wt.%, from 40 wt.% to 78 wt.%, from 50 wt.% to 77 wt.%, from 60 wt.% to 76 wt.%, from 40 wt.% to 60 wt.%, from 20 wt.% to 50 wt.%, or from 65 wt.% to 75 wt.%, wherein all weight percentages are based on the total weight of the one or more propylene-based copolymer compositions and the one or more polybutene elastomers, and each polybutene elastomer is characterized by one or more of:
   (1) is a copolymer of obtained by the polymerization of butene-1 and ethylene;
   (2) has a melt flow rate (190° C./2.16 kg) in the range of from 0.5 g/10 min. to 4 g/10 min., a density in the range of from 0.870 g/cm³ to 0.915 g/cm³, a tensile modulus in the range of from 1 MPa to 100 MPa, from 2 MPa to 90 MPa, from 3 MPa to 80 MPa, from 4 MPa to 70 MPa, from 5 MPa to 60 MPa, or from 10 MPa to 50 MPa, a tensile elongation at break of greater than or equal to 300%, 400%, 500% or 600%, or any combination thereof; and/or
   (3) has an ethylene derived units content in the range of from 15.10% by mol to 18.00%, from 15.50% by mol to 17% by mol, or from 15.50% by mol to 16.50% by mol; and/or
   (4) has a molecular weight distribution M_{w}/Mₙ less than 3; and/or
   (5) has hardness shore A (measured according to ISO 868) less than 65, or less than 60; and/or
   (6) has a tension set less than 30% or less than 20% at 100% of deformation (ISO 2285); and/or
   (7) does not show a melting point after it has been melted according to the common DSC procedure; however, it is crystallizable, i.e. about 10 days after it has been melted, the copolymer shows a melting point and a melting enthalpy; and/or
   (8) has a melting enthalpy, measured after 10 days of aging at room temperature, in the range of from 4 J/g to 15 J/g, or from 5 J/g to 10 J/g; and/or
   (9) has a good balance between hardness and elastic behavior better described in term of tension set, other than it shows good values of clarity; and/or
   (10) has a tensile stress at break measured according to ISO 527 in the range of from 3 MPa to 20 MPa, or from 4 MPa and 13 MPa; and/or
   (11) has an elongation at break measured according to ISO 527 in the range of from 550% to 800%, or from 600% to 750%; and/or
   (12) has a high molecular weight, expressed in terms of an intrinsic viscosity (“IV”) greater than 1, greater than 1.5, or greater than 2. In some embodiments, the IV is less than or equal to 3; and/or
   (13) is polymerized in a process comprising a metallocene catalyst, a Ziegler-Natta catalyst, or a combination thereof; and/or
   (14) has a tensile modulus in the range of from 6 MPa to 30 MPa, from 8 MPa to 25 MPa, from 10 MPa to 20 MPa, or from 12 MPa to 15 MPa; and/or
   (15) has a gloss less than or equal to 25 GU, less than or equal to 20 GU, less than or equal to 15 GU, less than or equal to 12 GU, or less than or equal to 10 GU; and/or
   (16) has haze greater than or equal to 60%, greater than or equal to 65%, greater than or equal to 70%, greater than or equal to 75%, greater than or equal to 80%, or greater than or equal to 85%; and/or
   (17) has a tensile stress at break in the range of from 6 MPa to 30 MPa, from 7 MPa to 25 MPa, from 8 MPa to 20 MPa, from 25 MPa to 9 MPa, or from 10 MPa to 12 MPa; and/or
   (18) has an elongation at break greater than or equal to 300%, greater than or equal to 400%, greater than or equal to 500%, greater than or equal to 600%, greater than or equal to 700%, or greater than or equal to 800%; and/or
   (19) has puncture resistance in the range of from 4.0 N to 5.0 N, from 3.5 N to 5.5 N, from 3.0 N to 6.0 N, from 2.5 N to 6.5 N, or from 2.0 N to 7.0 N; and/or
   (20) has a Shore A hardness (after 15 seconds) in the range of from 50 to 70, from 52 to 68, from 53 to 67, from 54 to 66, or from 55 to 65; and/or
   (21) has a machine direction tear resistance in the range of from 20 N to 36 N, in the range of from 22 N to 34 N, in the range of from 23 N to 32 N, in the range of from 24 N to 30 N, or in the range of from 25 N to 28 N and/or;
   (22) has a normalized machine direction tear resistance in the range of from 40 N/mm to 72 N/mm, in the range of from 44 N/mm to 68 N/mm, in the range of from 46 N/mm to 64 N/mm, in the range of from 48 N/mm to 60 N/mm, or in the range of from 50 N/mm to 56 N/mm; and/or
   (23) has a machine direction tear resistance maximum extension in the range of from 80 mm to 130 mm, from 85 mm to 125 mm, from 90 mm to 120 mm, from 95 mm to 115 mm, or from 100 mm to 110 mm; and/or
   (24) has a transverse tear resistance in the range of from 20 N to 36 N, in the range of from 22 N to 34 N, in the range of from 23 N to 32 N, in the range of from 24 N to 30 N, or in the range of from 25 N to 28 N; and/or
   (25) has a normalized transverse tear resistance in the range of from 40 N/mm to 72 N/mm, in the range of from 44 N/mm to 68 N/mm, in the range of from 46 N/mm to 64 N/mm, in the range of from 48 N/mm to 60 N/mm, or in the range of from 50 N/mm to 56 N/mm; and/or
   (26) has a transverse tear resistance maximum extension in the range of from 80 mm to 130 mm, from 85 mm to 125 mm, from 90 mm to 120 mm, from 95 mm to 115 mm, or from 100 mm to 110 mm; and
the film is characterized by one or more of:
(A) having a haze value of less than or equal to 23%, less than or equal to 20%, less than or equal to 17%, less than or equal to 14%, or less than or equal to 10%; and/or
(B) having a tensile modulus in the range of from 10 MPa to 350 MPa, from 15 MPa to 300 MPa, from 20 MPa to 250 MPa, from 25 MPa to 200 MPa, or from 30 MPa to 175 MPa; and/or
(C) comprising a blend composition comprising the one or more propylene-based copolymer compositions and the one or more polybutene elastomers has a tensile modulus in the range of from 10 MPa to 350 MPa, from 15 MPa to 300 MPa, from 20 MPa to 250 MPa, from 25 MPa to 200 MPa, or from 30 MPa to 175 MPa; and/or
(D) comprising the blend composition comprising the one or more propylene-based copolymer compositions and the one or more polybutene elastomers has a gloss greater than or equal to 15 GU, greater than or equal to 25 GU, greater than or equal to 35 GU, greater than or equal to 45 GU, greater than or equal to 55 GU, or greater than or equal to 65 GU; and/or
(E) comprising the blend composition comprising the one or more propylene-based copolymer compositions and the one or more polybutene elastomers has haze less than or equal to 65%, less than or equal to 55%, less than or equal to 45%, less than or equal to 35%, less than or equal to 25%, or less than or equal to 15%; and/or
(F) comprising the blend composition comprising the one or more propylene-based copolymer compositions and the one or more polybutene elastomers has a tensile stress at break in the range of from 1 MPa to 100 MPa, from 2 MPa to 80 MPa, from 20 MPa to 60 MPa, from 25 MPa to 45 MPa, or from 15 MPa to 30 MPa; and/or
(G) comprising the blend composition comprising the one or more propylene-based copolymer compositions and the one or more polybutene elastomers has an elongation at break greater than or equal to 300%, greater than or equal to 400%, greater than or equal to 500%, greater than or equal to 600%, greater than or equal to 700%, or greater than or equal to 800%; and/or
(H) having a 1% secant modulus of from 30 MPa to 360 MPa, from 40 MPa to 250 MPa, from 50 MPa to 200 MPa, or from 60 MPa to 150 MPa; and/or
(I) having a 2% secant modulus of from 25 MPa to 260 MPa, from 30 MPa to 230 MPa, from 35 MPa to 200 MPa, or from 40 MPa to 150 MPa; and/or
(J) having puncture resistance greater than or equal to 75 N, greater than or equal to 80 N, greater than or equal to 85 N, greater than or equal to 90 N, or greater than or equal to 100 N; and/or
(K) having a Shore A hardness (after 15 seconds) in the range of from 50 to 90, from 55 to 85, from 60 to 80, or from 65 to 75; and/or
(L) having a machine direction tear resistance of greater than or equal to 25 N, greater than or equal to 35 N, greater than or equal to 45 N, greater than or equal to 55 N, greater than or equal to 65 N, or greater than or equal to 75 N; and/or
(M) having a normalized machine direction tear resistance of greater than or equal to 50 N/mm, greater than or equal to 70 N/mm, greater than or equal to 90 N/mm, greater than or equal to 110 N/mm, greater than or equal to 130 N/mm, or greater than or equal to 150 N/mm; and/or
(N) having a machine direction tear resistance maximum extension of greater than or equal to 50 mm, greater than or equal to 60 mm, greater than or equal to 70 mm, greater than or equal to 80 mm, greater than or equal to 90 mm, or greater than or equal to 100 mm; and/or
(O) having a transverse direction tear resistance of greater than or equal to 25 N, greater than or equal to 35 N, greater than or equal to 45 N, greater than or equal to 55 N, greater than or equal to 65 N, or greater than or equal to 75 N; and/or
(P) having a normalized transverse direction tear resistance of greater than or equal to 50 N/mm, greater than or equal to 70 N/mm, greater than or equal to 90 N/mm, greater than or equal to 110 N/mm, greater than or equal to 130 N/mm, or greater than or equal to 150 N/mm; and/or
(Q) having a transverse tear resistance maximum extension of greater than or equal to 50 mm, greater than or equal to 60 mm, greater than or equal to 70 mm, greater than or equal to 80 mm, greater than or equal to 90 mm, or greater than or equal to 100 mm.

In some embodiments, the one or more propylene-based copolymer compositions and the one or more polybutene elastomers are blended by adding the blend components to an extruder in flake and/or pellet form and subjecting the physical mixture to compounding conditions sufficient to intimately mix the blend components to form a blend melt composition without substantial alteration of the original blend components. The blend melt composition can be extruded to form a cast film.

In some embodiments, the film comprises:
(A) Two outer layers having of one or more propylene-based copolymer compositions, and each propylene-based copolymer composition is characterized by one or more of:
   (1) is a blend of random copolymers of propylene and one or more α-olefins, such that the units derived from the different monomers and/or comonomers occur randomly along the polymer chain; wherein the α-olefins are selected from ethylene and C₄-C₈ monomers, from ethylene and a C₄-C₆ monomers, or from ethylene and butene; and/or
   (2) is a semicrystalline propylene copolymer composition having: (A) 20-80 wt.% of one or more propylene-based components selected from the group consisting of propylene/ethylene copolymers containing 1-7 wt.% of ethylene; copolymers of propylene with one or more C₄-C₈ α-olefins, containing 2-10 wt.% of the C₄-C₈ α-olefins; or terpolymers of propylene with ethylene and one or more C₄-C₈ α-olefins, containing 0.5-4.5 wt.% of ethylene and 2-6 wt.% of C₄-C₈ α-olefins, provided that the total content of ethylene and C₄-C₈ α-olefins in be equal to or lower than 6.5 wt.%; and (B) 20-80 wt.% of one or more propylene-based components selected from the group consisting of copolymers of propylene with one or more C₄-C₈ α-olefins, containing from more than 10 wt.% to 30 wt.% of C₄-C₈ α-olefins, or terpolymers of propylene with ethylene and one or more C₄-C₈ α-olefins, containing 1-7 wt.% of ethylene and 6-15 wt.% of C₄-C₈ α-olefins;
   (3) has a melt flow rate between 2 to 15 g/10 min.; and/or
   (4) has a density in the range of from 0.88 g/cm³ to 0.92 g/cm³, from 0.88 g/cm3 to 0.92 g/cm³, from 0.89 g/cm³ to 0.91 g/cm³, from 0.895 g/cm³ to 0.905 g/cm³, or from 0.898 g/cm³ to 0.902 g/cm³; and/or
   (5) has a tensile modulus in the range of from 100 MPa to 1,000 MPa, from 150 MPa to 950 MPa, from 250 MPa to 900 MPa, from 350 MPa to 850 MPa, or from 450 MPa to 800 MPa; and/or
   (6) has a gloss greater than or equal to 50 GU, greater than or equal to 60 GU, greater than or equal to 70 GU, greater than or equal to 80 GU, or greater than or equal to 90 GU; and/or
   (7) has haze less than or equal to 45%, less than or equal to 35%, less than or equal to 25%, or less than or equal to 15%; and/or
   (8) has a tensile stress at break in the range of from 15 MPa to 75 MPa, from 20 MPa to 55 MPa, from 25 MPa to 45 MPa, or from 30 MPa to 35 MPa;
   (9) has an elongation at break in the range of from 50% to 500%, from 100% to 400%, from 150% to 300%, or from 200% to 250%; and/or
   (10) has a 1% secant modulus of from 5 MPa to 30 MPa, from 6 MPa to 25 MPa, from 8 MPa to 20 MPa, or from 10 MPa to 15 MPa; and/or
   (11) In some embodiments, the propylene-based copolymer composition or a film formed from the propylene-based copolymer composition has a 2% secant modulus of from 200 MPa to 650 MPa, from 250 MPa to 600 MPa, from 300 MPa to 550 MPa, or from 350 MPa to 500 MPa; and
(B) A core layer consisting essentially of one or more polybutene elastomers, and each polybutene elastomer is characterized by one or more of:
   (1) is a copolymer of obtained by the polymerization of butene-1 and ethylene; and/or
   (2) has a melt flow rate (190° C./2.16 kg) in the range of from 0.5 g/10 min. to 4 g/10 min., a density in the range of from 0.870 g/cm³ to 0.915 g/cm³, a tensile modulus in the range of from 1 MPa to 100 MPa, from 2 MPa to 90 MPa, from 3 MPa to 80 MPa, from 4 MPa to 70 MPa, from 5 MPa to 60 MPa, or from 10 MPa to 50 MPa, a tensile elongation at break of greater than or equal to 300%, or any combination thereof; and/or
   (3) has an ethylene derived units content in the range of from 15.10% by mol to 18.00%, from 15.50% by mol to 17% by mol, or from 15.50% by mol to 16.50% by mol; and/or
   (4) has a molecular weight distribution M_{w}/Mₙ less than 3; and/or
   (5) has hardness shore A (measured according to ISO 868) less than 65, or less than 60; and/or
   (6) has a tension set less than 30% or less than 20% at 100% of deformation (ISO 2285); and/or
   (7) does not show a melting point after it has been melted according to the common DSC procedure; however, it is crystallizable, i.e. about 10 days after it has been melted, the copolymer shows a melting point and a melting enthalpy; and/or
   (8) has a melting enthalpy, measured after 10 days of aging at room temperature, in the range of from 4 J/g to 15 J/g, or from 5 J/g to 10 J/g; and/or
   (9) has a good balance between hardness and elastic behavior better described in term of tension set, other than it shows good values of clarity; and/or
   (10) has a tensile stress at break measured according to ISO 527 in the range of from 3 MPa to 20 MPa, or from 4 MPa and 13 MPa; and/or
   (11) has an elongation at break measured according to ISO 527 in the range of from 550% to 800%, or from 600% to 750%; and/or
   (12) has a high molecular weight, expressed in terms of an intrinsic viscosity (“IV”) greater than 1, greater than 1.5, or greater than 2. In some embodiments, the IV is less than or equal to 3; and/or
   (13) is polymerized in a process comprising a metallocene catalyst, a Ziegler-Natta catalyst, or a combination thereof; and/or
   (14) has a tensile modulus in the range of from 6 MPa to 30 MPa, from 8 MPa to 25 MPa, from 10 MPa to 20 MPa, or from 12 MPa to 15 MPa; and/or
   (15) has a gloss less than or equal to 25 GU, less than or equal to 20 GU, less than or equal to 15 GU, less than or equal to 12 GU, or less than or equal to 10 GU; and/or
   (16) has haze greater than or equal to 60%, greater than or equal to 65%, greater than or equal to 70%, greater than or equal to 75%, greater than or equal to 80%, or greater than or equal to 85%; and/or
   (17) has a tensile stress at break in the range of from 6 MPa to 30 MPa, from 7 MPa to 25 MPa, from 8 MPa to 20 MPa, from 25 MPa to 9 MPa, or from 10 MPa to 12 MPa; and/or
   (18) has an elongation at break greater than or equal to 300%, greater than or equal to 400%, greater than or equal to 500%, greater than or equal to 600%, greater than or equal to 700%, or greater than or equal to 800%; and/or
   (19) has puncture resistance in the range of from 4.0 N to 5.0 N, from 3.5 N to 5.5 N, from 3.0 N to 6.0 N, from 2.5 N to 6.5 N, or from 2.0 N to 7.0 N; and/or
   (20) has a Shore A hardness (after 15 seconds) in the range of from 50 to 70, from 52 to 68, from 53 to 67, from 54 to 66, or from 55 to 65; and/or
   (21) has a machine direction tear resistance in the range of from 20 N to 36 N, in the range of from 22 N to 34 N, in the range of from 23 N to 32 N, in the range of from 24 N to 30 N, or in the range of from 25 N to 28 N; and/or
   (22) has a normalized machine direction tear resistance in the range of from 40 N/mm to 72 N/mm, in the range of from 44 N/mm to 68 N/mm, in the range of from 46 N/mm to 64 N/mm, in the range of from 48 N/mm to 60 N/mm, or in the range of from 50 N/mm to 56 N/mm; and/or
   (23) has a machine direction tear resistance maximum extension in the range of from 80 mm to 130 mm, from 85 mm to 125 mm, from 90 mm to 120 mm, from 95 mm to 115 mm, or from 100 mm to 110 mm; and/or
   (24) has a transverse tear resistance in the range of from 20 N to 36 N, in the range of from 22 N to 34 N, in the range of from 23 N to 32 N, in the range of from 24 N to 30 N, or in the range of from 25 N to 28 N; and/or
   (25) has a normalized transverse tear resistance in the range of from 40 N/mm to 72 N/mm, in the range of from 44 N/mm to 68 N/mm, in the range of from 46 N/mm to 64 N/mm, in the range of from 48 N/mm to 60 N/mm, or in the range of from 50 N/mm to 56 N/mm; and/or
   (26) has a transverse tear resistance maximum extension in the range of from 80 mm to 130 mm, from 85 mm to 125 mm, from 90 mm to 120 mm, from 95 mm to 115 mm, or from 100 mm to 110 mm; and/or
the film is characterized by having one or more of:
(A) a haze value of less than or equal to 23%, less than or equal to 20%, less than or equal to 17%, less than or equal to 14%, or less than or equal to 10%; and/or
(B) a tensile modulus in the range of from 10 MPa to 350 MPa, from 15 MPa to 300 MPa, from 20 MPa to 250 MPa, from 25 MPa to 200 MPa, or from 30 MPa to 175 MPa; and/or
(C) comprising a blend composition comprising the one or more propylene-based copolymer compositions and the one or more polybutene elastomers has a tensile modulus in the range of from 10 MPa to 350 MPa, from 15 MPa to 300 MPa, from 20 MPa to 250 MPa, from 25 MPa to 200 MPa, or from 30 MPa to 175 MPa; and/or
(D) comprising the blend composition comprising the one or more propylene-based copolymer compositions and the one or more polybutene elastomers has a gloss greater than or equal to 15 GU, greater than or equal to 25 GU, greater than or equal to 35 GU, greater than or equal to 45 GU, greater than or equal to 55 GU, or greater than or equal to 65 GU; and/or
(E) comprising the blend composition comprising the one or more propylene-based copolymer compositions and the one or more polybutene elastomers has haze less than or equal to 65%, less than or equal to 55%, less than or equal to 45%, less than or equal to 35%, less than or equal to 25%, or less than or equal to 15%; and/or
(F) comprising the blend composition comprising the one or more propylene-based copolymer compositions and the one or more polybutene elastomers has a tensile stress at break in the range of from 1 MPa to 100 MPa, from 2 MPa to 80 MPa, from 20 MPa to 60 MPa, from 25 MPa to 45 MPa, or from 15 MPa to 30 MPa; and/or
(G) comprising the blend composition comprising the one or more propylene-based copolymer compositions and the one or more polybutene elastomers has an elongation at break greater than or equal to 300%, greater than or equal to 400%, greater than or equal to 500%, greater than or equal to 600%, greater than or equal to 700%, or greater than or equal to 800%; and/or
(H) having a 1% secant modulus of from 30 MPa to 360 MPa, from 40 MPa to 250 MPa, from 50 MPa to 200 MPa, or from 60 MPa to 150 MPa; and/or
(I) having a 2% secant modulus of from 25 MPa to 260 MPa, from 30 MPa to 230 MPa, from 35 MPa to 200 MPa, or from 40 MPa to 150 MPa; and/or
(J) having puncture resistance greater than or equal to 75 N, greater than or equal to 80 N, greater than or equal to 85 N, greater than or equal to 90 N, or greater than or equal to 100 N; and/or
(K) having a Shore A hardness (after 15 seconds) in the range of from 50 to 90, from 55 to 85, from 60 to 80, or from 65 to 75; and/or
(L) having a machine direction tear resistance of greater than or equal to 25 N, greater than or equal to 35 N, greater than or equal to 45 N, greater than or equal to 55 N, greater than or equal to 65 N, or greater than or equal to 75 N; and/or
(M) having a normalized machine direction tear resistance of greater than or equal to 50 N/mm, greater than or equal to 70 N/mm, greater than or equal to 90 N/mm, greater than or equal to 110 N/mm, greater than or equal to 130 N/mm, or greater than or equal to 150 N/mm; and/or
(N) having a machine direction tear resistance maximum extension of greater than or equal to 50 mm, greater than or equal to 60 mm, greater than or equal to 70 mm, greater than or equal to 80 mm, greater than or equal to 90 mm, or greater than or equal to 100 mm; and/or
(O) having a transverse direction tear resistance of greater than or equal to 25 N, greater than or equal to 35 N, greater than or equal to 45 N, greater than or equal to 55 N, greater than or equal to 65 N, or greater than or equal to 75 N; and/or
(P) having a normalized transverse direction tear resistance of greater than or equal to 50 N/mm, greater than or equal to 70 N/mm, greater than or equal to 90 N/mm, greater than or equal to 110 N/mm, greater than or equal to 130 N/mm, or greater than or equal to 150 N/mm; and/or
(Q) having a transverse tear resistance maximum extension of greater than or equal to 50 mm, greater than or equal to 60 mm, greater than or equal to 70 mm, greater than or equal to 80 mm, greater than or equal to 90 mm, or greater than or equal to 100 mm.

The following examples illustrate the presently disclosed compositions, films and methods of making such; however, those skilled in the art will recognize numerous variations within the spirit of the invention and scope of the claims. The following examples are included to demonstrate certain embodiments of the presently disclosed compositions, films and methods of making such. In no way should the following examples be read to limit, or to define, the scope of the invention.

### Test Methods

Listed below are test methods related to properties of films and/or sheets described above and as demonstrated in the examples below.

1% secant modulus (MPa): 1% secant modulus was measured according to ASTM D-638.

2% secant modulus (MPa): 1% secant modulus was measured according to ASTM D-638.

Density (g/cm³): Density measurements were made following ISO 1183-1.

Elongation @ break (%): Elongation at break was measured according to ASTM D-638.

Elongation @ yield (%): Elongation at yield was measured according to ASTM D-638.

Gloss (gloss units (“GU”)): Gloss measurements were made following ASTM D-2457 at a 60° angle.

Hardness (durometer units): Hardness was measured by Shore A hardness method according to ASTM D-2240.

Haze (%): Haze was measured according to ASTM 1003-13. This test is dependent on film sample thickness.

Transmittance (%): Transmittance was measured according to ASTM 1003-13. This test is dependent on film sample thickness.

Maximum extension (mm): Maximum extension, machine direction (“MD”) and transverse direction (“TD), was measured according to ASTM D-1004.

Melt flow rate (g/10 min.): Melt flow rate (MFR 230° C./2.16 kg or MFR 190° C./2.16 kg) measurements were made following ASTM D 1238, ISO 1133.

Nominal break elongation (%): Nominal break elongation was measured according to ASTM D-638.

Processability: Processability was assessed as previously defined. A film sample was “processable” if the tested polymer could be successfully formed into a cast film of commercial quality at commercially acceptable rates using the equipment and conditions described in the examples. A polymer composition had acceptable processability, or was “processable,” if it could be processed into a film capable of being subjected to the film property tests herein and if it was believed that such polymer could be run continuously through the cast film apparatus at the stated conditions in a steady state manner. A polymer composition did not have good processability, or was not “processable,” if it could not be processed into a film capable of being subjected to the film property tests herein or if it was believed that such polymer could not be run continuously through the cast film apparatus at the stated conditions in a steady state manner.

Puncture resistance (N): Puncture resistance was measured according to ASTM D-4833. This test is dependent on film sample thickness.

Tear resistance (N): Tear resistance, machine direction (“MD”) and transverse direction (“TD), was measured according to ASTM D-1004. This test is dependent on film sample thickness.

Tensile modulus (or Young’s modulus) (MPa): Tensile modulus was measured according to ASTM D-638.

Tensile stress @ break (Mpa): Tensile stress at break was measured according to ASTM D-638. This test is dependent on film sample thickness. For the measurements provided here, a thickness of 20 mil (0.51 mm) was used.

Tension set (%): Tension set was measured according to ISO 2285.

### EXAMPLES

The following examples are included to demonstrate some embodiments of the invention. It should be appreciated by those of skill in the art that the techniques disclosed in the examples which follow represent techniques discovered by the inventor to function well in the practice of the invention, and thus can be considered to constitute acceptable modes for its practice. However, those of skill in the art should, in light of the present disclosure, appreciate that many changes can be made in the specific embodiments which are disclosed and still obtain a like or similar result without departing from the spirit and scope of the invention.

The following examples provide compositions and films that are useful as film layers, either individually or in multilayer structures including such layers, without limitation, as skin layers, soft skin layers, or encapsulant material for PV cells. The exemplary film layers, as disclosed herein, have comparable strength and softness to benchmark TPO resins with a greater degree of transparency.

### Raw Materials

Raw materials used herein are shown in Table 1, below.

TABLE 1

| Composition^{∗∗∗} | Type | Polymer Label | MFR (g/10 min) | Density (g/cc) | Tensile. Modulus (Mpa) |
|---|---|---|---|---|---|
| Thermoplastic polyolefin | Polypropylene/rubber alloy | TPO1 | 0.6^{∗} | 0.88 | 100 |
| Thermoplastic polyolefin | Polypropylene/rubber alloy | TPO2 | 0.9^{∗} | 0.88 | 210 |
| Thermoplastic polyolefin | Polypropylene/rubber alloy | TPO3 | 7.5^{∗} | 0.89 | 550 |
| Polypropylene | Medium modified polypropylene random copolymer | PC | 2.0^{∗} | 0.90 | 1,000 |
| Thermoplastic polyolefin | Propylene-based copolymer composition | PBCC | 5.5^{∗} | 0.90 | 550 |
| Plastomer | Butene-1-based polymer | PB | 1.3^{∗∗} | 0.870 | <10 |

^{∗} 230° C./2.16 kg
^{∗∗} 190° C./2.16 kg
^{∗∗∗} All materials available from LyondellBasell

In more detail, the butene-1-based copolymer plastomer (“PB”) is a 1-butene ethylene copolymer with an ethylene derived units content between 15.10% by mol to 18.00% by mol, wherein PB has the following properties: a) distribution of molecular weight Mw/Mn lower than 3; b) hardness shore A (measured according to ISO 868) lower than 65; c) tension set lower than 30% at 100% of deformation (ISO 2285) d) no melting point detectable at the DSC at the second heating scan; and e) melting enthalpy measured after 10 days of aging at room temperature comprised between 4 and 15 J/g. The propylene-based copolymer composition (“PBCC”) is a semicrystalline propylene copolymer composition having: (A) about 35 wt.% of a propylene-based component that is a propylene/ethylene copolymer containing about 3.7 wt.% of ethylene; and (B) about 65 wt.% of a propylene-based components that is a terpolymer of propylene with ethylene and a C4 α-olefins, containing about 3.3 wt.% of ethylene and about 10 wt.% of a C4 α-olefins.

TPO1 is a TPO having a balance of strength and softness suitable for automotive interior skin applications, but lacks the desired transparency for some newer applications. Blends of a medium-modified polypropylene random copolymer (“PC”), and a butene-1-based copolymer plastomer (“PB”), were attempted due to acceptable optical properties of both components. However, PC/PB blends did not meet modulus targets for softness until higher ratios of PB to PC, where the blend was no longer processable as a film. Blends of propylene-based copolymer composition (“PBCC”) and PB are disclosed herein. PBCC/PB blends have an improved balance of strength, softness, processability, and optical properties compared to PC/PB blends, which is believed to result from structural differences between PBCC and PC.

### Film Sample Preparation

Film Line 1 (“FL1”): Monolayer film samples having a thickness of 20 mil (0.51 mm) were prepared on a Killion cast film line (Killion Extruders, Inc., Cedar Grove, N.J., USA), which is a single extruder machine using a 0.75 in. (19 mm) screw with a pineapple style mixing tip and a 6 in. (152 mm) die. The apparatus has three chill rolls but was configured to operate with two chill rolls for these experiments. Shown below in Table 2 are temperature settings for the apparatus during these experiments:

TABLE 2

| Profile | Temperature (deg. F/deg. C) |
|---|---|
| Zone 1 | 350/177 |
| Zone 2 | 375/191 |
| Zone 3 | 400/204 |
| Clamp ring | 400/204 |
| Adapter | 400/204 |
| Die | 400/204 |
| Melt | 398/203 |
| Chill Roll 1 | 120/49 |
| Chill Roll 2 | 100/38 |

Film Line 2 (“FL2”): Three-layer structures were prepared on a Killion coextrusion sheet machine (Killion Extruders, Inc., Cedar Grove, N.J., USA) capable of producing five-layer sheet but configured for three layers with each layer fed from one of three total extruders, each having barrel length to barrel diameter (L/D) ratio of 24:1, a barrel diameter of about 2.54 cm (1 inch) to about 3.18 cm (1.25 inches), 3 barrel heating zones, and a 10 inch flat die to produce a continuous 8 inch specimen.. Monolayer structures were prepared by feeding the same material through each extruder.

### Examples 1-15

Examples 1-15 were sample films prepared on Film Lines 1 and 2 and shown below in Table 3. Data is reported on specimens that were die cut from a 20 mil (0.51 mm) film and then tested according to methods described in Tables 4-8, below. Each example is reported as the average (“Avg.”) and standard deviation (“SD”) of five (5) specimens, except where noted. Examples 1-6 were prepared from raw materials shown in Table 1. Examples 7-9 and 11-13 are films prepared from blends according to this disclosure. Example 15 is a multilayer film example prepared according to this disclosure. Examples 10 and 14 are comparative examples using blends of TPOs and butene-1-based polymers. TPO1 was selected as a benchmark for certain end-use applications to determine if the PBCC/PB blend or multilayer films had an improved or acceptable balance of softness (tensile modulus), strength (elongation tensile strength), and optical properties (haze, transmittance, and gloss).

TABLE 3

| Ex. | Sample Label | Specimen Composition | Line |
|---|---|---|---|
| 1 | TPO1-2 | 100% TPO1-2 | FL2 |
| 2 | TPO2-2 | 100% TPO2-2 | FL2 |
| 3 | TPO3-2 | 100% TPO3-2 | FL2 |
| 4 | PBCC-2 | 100% PBCC-2 | FL2 |
| 5 | PBCC-1 | 100% PBCC-1 | FL1 |
| 6 | PB-2 | 100% PB-2 | FL2 |
| 7 | 70 PBCC/30 PB-2 | 70% PBCC, 30% PB blend | FL2 |
| 8 | 50 PBCC/50 PB-2 | 50% PBCC, 50% PB blend | FL2 |
| 9 | 50 PBCC/50 PB-1 | 50% PBCC, 50% PB blend | FL1 |
| 10 | 50 TPO3/50 PB-2 | 50% TPO3, 50% PB blend | FL2 |
| 11 | 40 PBCC/60 PB-1 | 40% PBCC, 60% PB blend | FL1 |
| 12 | 30 PBCC/70 PB-2 | 30% PBCC, 70% PB blend | FL2 |
| 13 | 30 PBCC/70 PB-1 | 30% PBCC, 70% PB blend | FL1 |
| 14 | 30 TPO3/70 PB-2 | 30% TPO3, 70% PB blend | FL2 |
| 15 | PBCC/PB-3L-2 | 25% PBCC, 50% PB, 25% PBCC - 3 layer | FL2 |

### Optical Properties

Table 4 below shows results of tests of optical properties of gloss and haze for Examples 1-15.

Examples 1-3 show that films from tested TPOs have gloss in the range of from 17.2 GU to 44.4 GU and haze in the range of from 26.9% to 59.7%. Examples 4 and 5 show that films from tested propylene-based copolymers have gloss in the range of from 72.9 GU to <100 GU and haze in the range of from 10.6% to 23.3%. Examples 6 shows that a film from the tested butene-1-based copolymer has a gloss from 8.8 GU and a haze of 86.8%.

Inventive Examples 7-9, comprising a blend of 50% to 70% of a blend of a propylene-based polymer composition with a butene-1-based copolymer, have gloss in the range of from 14.2 GU to 73.9 GU and haze in the range of from 12.52% to 52.4%. Comparative Example 10, comprising a blend of a similar amount of a TPO with a butene-1-based copolymer, has a gloss of 8.8 GU and a haze of 86.8%. Examples 7-11 show that both gloss and haze are improved for blends of propylene-based polymer compositions with butene-1-based copolymers as compared to similar blends of a TPO with a butene-1-based copolymer.

Inventive Examples 11-13, comprising a blend of 30% to 40% of a blend of a propylene-based polymer composition with a butene-1-based copolymer, have gloss in the range of from 16.1 GU to 85.7 GU and haze in the range of from 6.99% to 63.4%. Comparative Example 14, comprising a blend of a similar amount of a TPO with a butene-1-based copolymer, has a gloss of 15.5 GU and a haze of 69.7%. Examples 11-14 show that both gloss and haze are improved for blends of propylene-based polymer compositions with butene-1-based copolymers as compared to similar blends of a TPO with a butene-1-based copolymer.

Inventive Example 15, comprising an A/B/A 3-layer film, wherein each A layer is 25% of the film thickness of propylene-based polymer composition, and the B core layer is 50% of the film thickness of butene-1-based copolymer. Therefore, Example 15 is a film comprising 50% of a propylene-based polymer composition and 50% of a butene-1-based copolymer. As with blends of propylene-based polymer compositions and butene-1-based copolymer, Example 15 shows that a combination of layers of propylene-based polymer compositions and butene-1-based copolymers produces films having better gloss and haze as compared to Examples 10 and 14, using blends of similar amounts of TPOs with butene-1-based copolymers.

An additional effect was observed within the population of blends of PBCC and PB in that films processed on FL1 exhibited better optical properties as compared to films processed on FL2. Examples 8, 9, and 15all contained 50% by weight of PBCC. However, inventive blend Example 9 and inventive multilayer Example 15 demonstrated gloss values of 73.9 GU and 52.2 GU, respectively, and haze values of 12.52% and 14.35%, while Example 8 had a gloss of 14.2 GU and haze of 52.4%. Example 11, processed on FL1, contains 40 percent by weight of PBCC and has a gloss of 85.7 GU and a haze of 6.99 %. Example 13, processed on FL1, contains 30 percent by weight of PBCC and has a gloss of 57.9 GU and a haze of 16.97 %. Example 12, processed on FL2 and has a gloss of 16.1 GU and a haze of 63.4%. This shows that processing films having blends or layers of PBCC and PB, as disclosed herein, can have gloss increased by a factor of three when processing the film on FL1 versus FL2, and haze decreased by a factor of three when processing the film on FL1 versus FL2. Examples 8, 9, and 15 all contained 50% by weight of PBCC.

The blends of Examples 7-9, 11-13, and 15 show an improvement in gloss and haze versus PBCC alone. Examples 9, 11, and 14, produced on FL1, Examples 7, 8, 12, 13, and 15, produced on FL2. It should be noted that FL2 was not designed for producing film with exceptional optical properties. Without wishing to be bound to any particular theory, it is believed that optical performance was degraded to some extent where blends containing PB contacted the chill roll in the FL2 as configured for these experiments, based on observed inconsistent surface appearance of these blends. However, optical performance of Examples 7-9, 11, and 13 show a favorable and reliable trend. Example 15 is believed to exhibit improved optical properties even though produced on FL2, since outer layers contained only PBCC.

Transmittance was measured for Examples 6-8, 12, and 13, using a film thickness of 20 mil (0.51 mm). Transmission results equal to or greater than 90% are meaningful in solar applications. As shown in Table 4, all of Examples 6-8, 12, and 13 had a transmission level of 91% or more. This shows that the presently described films would allow for light to pass through solar module layers to underlying components such as PV electronic components. For automotive applications, transmission is not as critical as haze which impacts the “clarity” or readability. However, these transmission levels would be acceptable to automotive applications, too.

TABLE 4

| Ex. | Specimen Composition | Gloss (GU) | | Haze (%) | | Transmittance (%) | |
|---|---|---|---|---|---|---|---|
| | | Avg. | SD | Avg. | SD | Avg. | SD |
| 1 | TPO1-2 | 22.1 | 3.02 | 40.7 | 2.66 | | |
| 2 | TPO2-2 | 44.4 | 1.63 | 26.9 | 0.72 | | |
| 3 | TPO3-2 | 17.2 | 8.39 | 59.7 | 5.27 | | |
| 4 | PBCC-2 | 72.9 | 1.62 | 23.3 | 1.04 | | |
| 5 | PBCC-1 | >100 | -- | 10.6 | -- | | |
| 6 | PB-2 | 8.8 | 0.2 | 86.8 | 0.26 | 91.0 | 0.33 |
| 7 | 70 PBCC/30 PB-2 | 23.5 | 2.4 | 29.6 | 2.68 | 91.6 | 0.09 |
| 8 | 50 PBCC/50 PB-2 | 14.2 | 0.7 | 52.4 | 1.08 | 92.2 | 0.12 |
| 9 | 50 PBCC/50 PB-1 | 73.9 | 3.5 | 12.52 | 0.84 | | |
| 10 | 50 TPO3/50 PB-2 | 13.8 | 0.3 | 78.4 | 0.5 | | |
| 11 | 40 PBCC/60 PB-1 | 85.7 | 6.8 | 6.99 | 0.71 | | |
| 12 | 30 PBCC/70 PB-2 | 16.1 | 0.2 | 63.4 | 0.97 | 91.7 | 0.35 |
| 13 | 30 PBCC/70 PB-1 | 57.9 | 4.1 | 16.97 | 1.17 | 91.7 | 0.23 |
| 14 | 30 TPO3/70 PB-2 | 15.5 | 0.2 | 69.7 | 0.70 | | |
| 15 | PBCC/PB-3L-2 | 52.2 | 1.0 | 14.35 | 0.21 | | |

### Tensile Properties

Table 5 below shows results of tests related to tensile properties, in particular tensile stress at break and elongation at break. Examples 1-6 show tensile properties of raw materials. Examples 7-9, 11-13, and 15 show examples prepared according to this disclosure. Examples 10 and 14 are comparative examples. Tests were performed according to ASTM D-638. Crosshead speed was 20 inches/minute (8.5 mm/second). Tensile strength of Examples 6-10 and 12-14 is reported as stress at maximum elongation since all reached a maximum elongation of >800% without breaking.

The predicted values of tensile stress at break for inventive Examples 7-9, 11-13, and 15 based on a weighted average of constituent components are respectively 25.8 MPa, 21.7 MPa, 21.7 MPa, 19.62 MPa, 17.58 MPa, 17.58 MPa, and 18.60 MPa. A comparison of measured tensile stress at break to predicted tensile stress at break, expressed as a percentage, for Examples 7-9, 11-13, and 15 are respectively 113%, 111%, 100%, 94%, 100%, 108%, and 107%, and the average of these values is 105%. The predicted values of tensile stress at break for comparative Examples 10 and 14 based on a weighted average of constituent components are respectively 18.6 MPa and 15.74 MPa. A comparison of measured tensile stress at break to predicted tensile stress at break, expressed as a percentage, for Examples 10 and 14 are respectively 108% and 103%, and the average of these values is 105%. This is believed to show that tensile stress at break for films of blends or layers of either PBCC or TPO with PB are a weight average of the tensile stress at break of the individual components. PBCC has equivalent or higher tensile stress at break that the tested TPOs. Therefore, PBCC/PB combinations are believed to have equivalent or higher tensile stress at break than TPO/PB combinations having the same PB content.

Although values were recorded for elongation at break and nominal break elongation, no specimens in Examples 8-14 actually broke before the test apparatus was fully extended. Only two specimens broke in Example 7. Example 15 reports values of 750 MPa for elongation at break and 590 MPa for nominal break elongation. These parameters are an indication of a polymer to resist changes of shape without crack formation. Since all of Examples 7-15 for elongation at break and nominal break elongation exceeding 500%, it is believed that performance of these films in the intended application would no be distinguishable on this basis—i.e., no meaningful loss of performance for these parameters as a result of substituting PBCC for TPO in the films.

Values reported for tensile at yield and elongation at yield are not believed to show meaningful differences in these parameters for the intended application between inventive Examples 7-9, 11-13, and 15 and comparative Examples 10 and 14.

TABLE 5

| Ex. | Specimen Composition | Tensile at Break (MPa) | | Elong. at Break (%) | | Nom. Break Elong. (%) | | Tensile at Yield (MPa) | | Elongation at Yield (%) | |
|---|---|---|---|---|---|---|---|---|---|---|---|
| | | Avg. | SD | Avg. | SD | Avg. | SD | Avg. | SD | Av g. | SD |
| 1¹ | TPO1-2 | 22.84 | 3.10 | 700 | 110 | 730 | 46 | 7.79 | 0.186 | 36 | 2 |
| 2 | TPO2-2 | 29.33 | 1.59 | 700 | 40 | 740 | 19 | 11.51 | 0.248 | 28 | 0.9 |
| 3 | TPO3-2 | 25.74 | 1.52 | 640 | 55 | 780 | 53 | 16.62 | 0.483 | 12 | 1 |
| 4 | PBCC-2 | 31.88 | 1.59 | 630 | 44 | 710 | 30 | 21.93 | 0.586 | 15 | 0.6 |
| 6^{2,3} | PB-2 | 11.45 | 0.60 | 860 | 0 | 760 | 17 | -- | -- | -- | -- |
| 7⁴ | 70 PBCC/30 PB-2 | 29.1 | 1.3 | 790 | 71 | 820 | 34 | 11.10 | 0.186 | 27 | 1.2 |
| 8² | 50 PBCC/50 PB-2 | 24.1 | 0.90 | 860 | 0 | 840 | 130 | 6.25 | 0.103 | 39 | 1.1 |
| 9² | 50 PBCC/50 PB-1 | 21.7 | 0.76 | 860 | 0 | 740 | 3.1 | 4.88 | 0.138 | 35 | 1.1 |
| 10² | 50 TPO3/50 PB-2 | 20.0 | 0.42 | 860 | 2 | 870 | 110 | 5.47 | 0.152 | 45 | 4.5 |
| 11² | 40 PBCC/60 PB-1 | 18.35 | 0.60 | 860 | 1 | 740 | 1.8 | -- | -- | -- | -- |
| 12² | 30 PBCC/70 PB-2 | 17.60 | 0.52 | 860 | 0 | 770 | 6.1 | 3.63 | 0.055 | 57 | 2.3 |
| 13² | 30 PBCC/70 PB-1 | 18.98 | 0.51 | 860 | 3 | 730 | 6.3 | 3.65 | 0.097 | 44 | 2.1 |
| 14² | 30 TPO3/70 PB-2 | 16.15 | 0.46 | 860 | 0 | 780 | 7.2 | -- | -- | -- | -- |
| 15 | PBCC/PB-3L-2 | 19.87 | 1.44 | 590 | 36 | 750 | 75 | 12.07 | 0.441 | 15 | 0.2 |

1. One specimen did not break
2. Specimens did not break and went to full extension of frame.
3. Specimens did not yield.
4. Two specimens did not break.

Table 6 below shows results of further tests related to tensile properties of 1% secant modulus, 2% secant modulus, and tensile modulus (Young’s modulus). Examples 1-6 show tensile properties of raw materials. Examples 7-9, 11-13, and 15 show examples prepared according to this disclosure. Examples 10 and 14 are comparative examples. Tests were performed according to ASTM D-638. Crosshead speed was 0.5 in/minute (0.21 mm/second). All specimens were Type IV.

Values reported for 1% secant modulus, 2% secant modulus, and tensile modulus are not believed to show meaningful differences in these parameters for the intended application between inventive Examples 7-9, 11-13, and 15 and comparative Examples 10 and 14.

TABLE 6

| Ex. | Specimen Composition | 1% Secant Modulus (MPa) | | 2% Secant Modulus (MPa) | | Tensile Modulus (MPa) | |
|---|---|---|---|---|---|---|---|
| | | Avg. | SD | Avg. | SD | Avg. | SD |
| 1 | TPO1-2 | 182.1 | 7.65 | 125.9 | 4.97 | 136.7 | 8.34 |
| 2 | TPO2-2 | 260 | 3.40 | 189.6 | 2.63 | 215 | 3.62 |
| 3¹ | TPO3-2 | 647 | 10.96 | 468 | 5.70 | 648 | 3.48 |
| 4 | PBCC-2 | 597 | 13.38 | 463 | 7.03 | 568 | 7.24 |
| 6³ | PB-2 | 17.31 | 0.33 | 12.90 | 0.50 | 14.75 | 0.90 |
| 7⁴ | 70 PBCC/30 PB-2 | 224 | 11.24 | 162.1 | 5.93 | 172.4 | 9.52 |
| 8⁴ | 50 PBCC/50 PB-2 | 126.9 | 2.90 | 83.5 | 1.999 | 57.3 | 3.59 |
| 9 | 50 PBCC/50 PB-1 | 61.5 | 0.331 | 51.4 | 0.538 | 54.0 | 1.034 |
| 10^{2,4} | 50 TPO3/50 PB-2 | 130.3 | 3.38 | 91.1 | 3.17 | 77.9 | 2.71 |
| 11 | 40 PBCC/60 PB-1 | 33.7 | 0.83 | 28.0 | 0.62 | 25.6 | 1.52 |
| 12^{1,3} | 30 PBCC/70 PB-2 | 38.6 | 1.862 | 31.5 | 1.585 | 29.5 | 3.38 |
| 13 | 30 PBCC/70 PB-1 | 39.6 | 1.724 | 32.7 | 1.310 | 31.9 | 3.30 |
| 14³ | 30 TPO3/70 PB-2 | -- | -- | 40.6 | -- | -- | -- |
| 15⁴ | PBCC/PB-3L-2 | 353 | 7.58 | 259 | 8.27 | 303 | 10.20 |

1. Only averaged four specimens. Apparatus failure on one.
2. Only averaged three specimens. Apparatus failure on two.
3. Used 0.05 (10x smaller) pound-force preload.
4. Used normal 0.5 pound-force preload.

### Puncture Resistance and Hardness

Table 7 below shows results of tests of puncture resistance and hardness for Examples 1, 6-8, 12, and 14. Puncture resistance tests were performed according to ASTM D-4833. Shore A hardness tests were performed according to ASTM D-2240. However, specimens were stacked to perform hardness testing, since individual specimens did not meet the minimum thickness requirements. These samples were all prepared on FL2.

Example 1 shows puncture resistance and hardness for benchmark TPO1-2. Example 6 shows puncture resistance and hardness for PB. Inventive Examples 7, 8, and 12 show puncture resistance of 116.1 N, 102.3 N, and 90.9 N, respectively, all outperforming the 70.47 N measured for comparative Example 14. Values reported for Shore A hardness are not believed to show a meaningful difference in this parameter for the intended application between inventive Examples 7, 8, and 12, and comparative Example 14.

TABLE 7

| Ex. | Specimen Composition | Puncture Resistance (N) | | Shore A Hardness | |
|---|---|---|---|---|---|
| | | Avg. | SD | Max | At 15 sec. |
| 1 | TPO1-2 | 110.5 | 3.8 | 86 | 83 |
| 6 | PB-2 | 62.4 | 4.29 | 65 | 60 |
| 7 | 70 PBCC/30% PB-2 | 116.1 | 9.16 | 89 | 87 |
| 8 | 50 PBCC/50% PB-2 | 102.3 | 3.8 | 78 | 74 |
| 12 | 30 PBCC/70 PB-2 | 90.9 | 5.04 | 76 | 66 |
| 14 | 30 TPO3/70 PB-2 | 70.5 | 6.06 | 80 | 74 |

### Puncture Resistance and Hardness

Table 8 below shows results of tests of tear resistance in both machine direction and transverse direction for Examples 1, 6-8, 12, and 14. Puncture resistance tests were performed according to ASTM D-1004. Tear resistance tests were performed according to ASTM D-1004. These samples were prepared on FL2. Film thickness of samples is shown in columns entitled “T”.

Example 1 shows tear resistance for benchmark TPO1-2. Example 6 shows tear resistance for PB-2. Inventive Examples 7, 8, and 12 show MD tear resistance of 102.3 N, 72.1 N, and 48.0 N, respectively, all outperforming the 46.6 N measured for comparative Example 14. Inventive Examples 7, 8, and 12 show TD tear resistance of 101.0 N, 71.3 N, and 45.8 N, respectively, all outperforming the 45.2 N measured for comparative Example 14.

TABLE 8

| E x. | Specimen Composition | Machine Direction | | | | | Transverse Direction | | | | |
|---|---|---|---|---|---|---|---|---|---|---|---|
| | | T (mm) | Tear Resistance (N) | | Max. Extension (mm) | | T (mm) | Tear Resistance (N) | | Max. Extension (mm) | |
| | | Avg. | Avg. | SD | Avg. | SD | Avg. | Avg. | SD | Avg. | SD |
| 1 | TPO1-2 | 0.511 | 66.5 | 1.205 | 58.1 | 3.642 | 0.492 | 62.8 | 1.971 | 50.5 | 2.59 |
| 6 | PB-2 | 0.521 | 26.7 | 1.449 | 109.1 | 3.658 | 0.521 | 26.4 | 1.512 | 105.0 | 3.34 |
| 7 | 70 PBCC / 30% PB-2 | 0.504 | 102.3 | 7.17 | 48.0 | 3.85 | 0.481 | 101.0 | 8.81 | 50.4 | 10.47 |
| 8 | 50 PBCC / 50% PB-2 | 0.47 | 72.1 | 3.23 | 70.8 | 13.11 | 0.468 | 71.3 | 2.67 | 75.0 | 14.40 |
| 12 | 30 PBCC / 70 PB-2 | 0.496 | 48.0 | 0.879 | 126.5 | 2.93 | 0.495 | 45.8 | 2.49 | 114.8 | 11.38 |
| 14 | 30 TPO3 / 70 PB-2 | 0.504 | 46.6 | 3.03 | 96.9 | 9.01 | 0.493 | 45.2 | 1.948 | 97.4 | 4.67 |

Although the present invention and its advantages have been described in detail, it should be understood that various changes, substitutions and alterations can be made herein without departing from the spirit and scope of the invention as defined by the appended claims. Ranges for various characteristics and attributes disclosed herein are listed as sequentially narrowing ranges. However, it should be understood that any lower endpoint of any ranges can be paired with any upper endpoint for the same characteristic or attribute, and such pairings are also intended to be disclosed herein. Moreover, the scope of the present application is not intended to be limited to the particular embodiments of the processes, machines, film structures, composition of layers, means, methods, and/or steps described in the specification. As one of the ordinary skill in the art will readily appreciate from the disclosure of the present invention, processes, machines, film structures, composition of layers, means, methods, and/or steps, presently existing or later to be developed that perform substantially the same function or achieve substantially the same result as the corresponding embodiments described herein, may be utilized according to the present invention. Accordingly, the appended claims are intended to include within their scope such processes, machines, film structures, composition of layers, means, methods, and/or steps.

What is claimed is:

1. A composition comprising:
a. a propylene-based copolymer composition; and
b. a polybutene elastomer; wherein:
i. the propylene-based copolymer composition and the polybutene elastomer are blended under melt conditions to form the composition, and
ii. the composition has a haze value of less than or equal to 23% and a tensile modulus in the range of from 10 MPa to 350 MPa.

2. The composition of claim 1 wherein the propylene-based copolymer composition is a blend of random copolymers of propylene and one or more α-olefins.

3. The composition of claim 1 wherein the propylene-based copolymer composition has a melt flow rate (230° C./2.16 kg) in the range of from 0.9 g/10 min. to 7.5 g/10 min.

4. The composition of claim 1 wherein the propylene-based copolymer composition has a density in the range of from 0.88 g/cm³ to 0.92 g/cm³.

5. The composition of claim 1 wherein the propylene-based copolymer composition has a tensile modulus in the range of from 100 MPa to 1,000 MPa.

6. The composition of claim 1 wherein the propylene-based copolymer composition is a blend of at least two random copolymers of propylene and one or more α-olefins.

7. The composition of claim 6 wherein the random copolymers of propylene and one or more α-olefins are produced in a polymerization process using a spherical Ziegler-Natta catalyst.

8. The composition of claim 7 wherein the polymerization process comprises two or more gas phase reactors in series operation.

9. The composition of claim 1 wherein the polybutene elastomer has a melt flow rate (190 C/2.16 kg) in the range of from 0.5 g/10 min. to 4 g/10 min.

10. The composition of claim 1 wherein the polybutene elastomer has a density in the range of from 0.870 g/cm³ to 0.915 g/cm³.

11. The composition of claim 1 wherein the polybutene elastomer has a tensile modulus in the range of from 1 MPa to 100 MPa.

12. The composition of claim 1 wherein the polybutene elastomer has a tensile elongation at break of greater than or equal to 300%.

13. The composition of claim 1 wherein the polybutene elastomer is polymerized in a process comprising a metallocene catalyst, a Ziegler-Natta catalyst, or a combination thereof.

14. The composition of claim 1 wherein the propylene-based copolymer composition is present in the composition in an amount in the range of from 20 wt.% to 80 wt.%, and the polybutene elastomer is present in the composition in an amount in the range of from 20 wt.% to 80 wt.%, wherein all weight percentages are based on the total weight of the propylene-based copolymer composition and the polybutene elastomer.

15. A film comprising the composition of claim 1.

16. The film of claim 15 wherein the film comprises:
a. two outer layers comprising the propylene-based copolymer composition; and
b. a core layer comprising the polybutene elastomer, wherein the core layer is disposed between the two outer layers.

17. The film of claim 16 wherein the thickness of the core layer is in the range of from 50% to 85% of the combined thickness of the core layer and two outer layers.

18. A process for making a film, the process comprising:
a. blending a propylene-based copolymer composition and a polybutene elastomer under melt conditions to form a blend melt composition; and
b. extruding the blend melt composition to form a film;
wherein the film has a haze value of less than or equal to 30% and a tensile modulus in the range of from 10 MPa to 350 MPa.

19. The process of claim 18 wherein the propylene-based copolymer composition is a blend of random copolymers of propylene and one or more α-olefins.

20. The process of claim 18 wherein the polybutene elastomer has a melt flow rate (190 C/2.16 kg) in the range of from 0.5 g/10 min. to 4 g/10 min.
